(19) United States
(12) Patent Application Publication
(10) Pub. No.: US 2020/0225784 A1
(43) Pub. Date: Jul. 16, 2020

(54) TOUCH SCREEN PANEL

(71) Applicant: KORTEK CORPORATION, INCHEON (KR)

(72) Inventors: Woo HWANGBO, Yongin-si (KR); Son Ou LEE, Seoul (KR); Hyeoung Kyu CHANG, Incheon (KR); Tae Heon NOH, Incheon (KR)

(21) Appl. No.: 16/644,187

(22) PCT Filed: Aug. 29, 2018
(86) PCT No.: PCT/KR2018/009969

§ 371 Date: Mar. 4, 2020

(30) Foreign Application Priority Data
Sep. 5, 2017 (KR) 10-2017-0113066

(51) Int. Cl. G06F 3/044; H01B 1/02; H01B 7/00

(52) U.S. Cl. CPC G06F 3/044; H01B 7/0009; H01B 1/02

(57) ABSTRACT

Provided is a touch screen panel including: a touch panel, which includes a plurality of transparent electrodes for sensing an electrical signal generated from a contact area, and has at least one hole; and a conductive member provided at a peripheral part of the at least one hole in order to form an electrical connection between the transparent electrodes electrically separated by one or more holes formed in the touch panel.

### CROSS-REFERENCE TO RELATED APPLICATIONS

This application claims priority to PCT Application No. PCT/KR2018/009969, having a filing date of Aug. 29, 2018, based on KR 10-2017-0113066, having a filing date of Sep. 5, 2017, the entire contents both of which are hereby incorporated by reference.

### FIELD OF TECHNOLOGY

The following relates to a touch screen panel, and more particularly, to a touch screen panel which allows a touch recognition operation to be normally performed even when a hole is formed in a touch panel provided in the touch screen panel.

### BACKGROUND

A touch screen panel is a device which is mounted on an upper surface of a display unit of an electronic device to execute a command touched and designated by a user and is used in various electronic devices such as automated teller machines (ATMs), mobile phones, game machines, and the like.

Methods of implementing a touch screen panel may be largely divided into resistive film methods and capacitive methods according to operation methods. A resistive film method (using a resistive touch screen) refers to a method of sensing a voltage change caused by layers being in contact with each other by a touch pressure, and a capacitance method (using a projected capacitive (PCAP) touch screen) refers to a method of sensing a capacitance change generated during touch and transmitting an electrical signal. A touch screen panel implemented in the capacitance method includes a transparent electrode pattern formed of a transparent conductive material such as indium tin oxide (ITO) and coupled to a back surface of a cover glass to sense a touch, a silver paste electrode which is coupled to an edge of a transparent electrode layer and transmits an electrical signal to a control unit, and a liquid-crystal display panel for displaying an image.

Meanwhile, the touch screen panel is also being applied to a game system. In order to install a manipulation button in the game system or to secure an aesthetic sense of design, it is necessary to form a hole in a touch panel provided in the touch screen panel. In this case, the touch panel of the touch screen panel implemented in the conventional capacitance method may recognize the user's touch manipulation using electrode channels disposed in an X-axis direction and electrode channels disposed in a Y-axis direction, which are arranged in a lattice. Accordingly, due to the hole formation, an area may be generated in which the user's touch manipulation cannot be recognized.

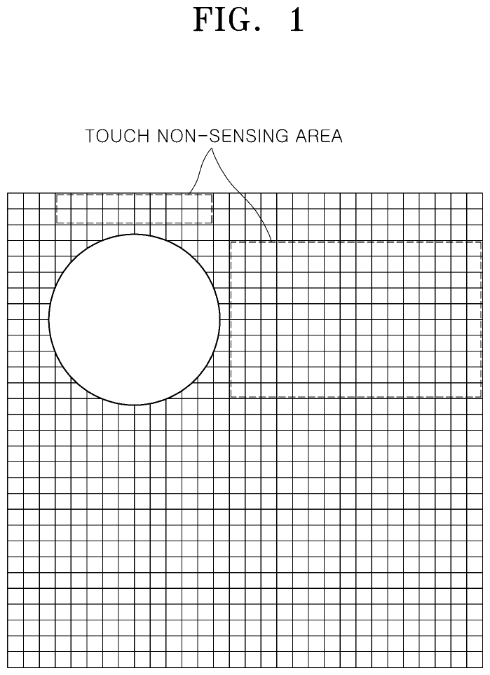

Referring to an example illustrated in FIG. 1, when a circular hole is generated in a touch panel, touch non-sensing areas are generated as illustrated in FIG. 1 and electrical signals generated in the touch non-sensing areas are not transmitted to a controller integrated circuit (IC) so that coordinates for an area in which a touch is generated cannot be obtained. Accordingly, software such as an application to be controlled according to touch manipulation may not be controlled.

Background art of embodiments of the present invention is disclosed in Korean Patent Application Publication No. 10-2009-0015414 (Published on Feb. 12, 2009).

### SUMMARY

An aspect relates to a touch screen panel in which a touch non-sensing area, which is generated when a predetermined hole is formed in a touch panel, is eliminated and thus a touch may be normally recognized regardless of whether the hole is formed in the touch panel.

One aspect of embodiments of the present invention provides a touch screen panel including a touch panel including a plurality of transparent electrodes for sensing an electrical signal generated in a touch area and having one or more holes formed therein, and a conductive member provided at a peripheral part of the one or more holes in order to electrically connect the transparent electrodes electrically separated by the one or more holes formed in the touch panel.

The touch panel may include a first electrode layer having one or more first electrode lines which electrically connect the plurality of transparent electrodes in a first direction, and a second electrode layer provided below the first electrode layer and having one or more second electrode lines which electrically connect the plurality of transparent electrodes in a second direction orthogonal to the first direction.

The conductive member may be formed to electrically connect the first electrode lines disconnected by the hole formed in the first electrode layer and electrically connect the second electrode lines disconnected by the hole formed in the second electrode layer.

The conductive member may be formed of silver (Ag) or copper (Cu) at the peripheral part of each of the one or more holes.

The touch screen panel may be mounted on a display device for a game system and may further include a cover glass unit provided above the touch panel and having one or more holes formed in an area corresponding to an area in which the one or more holes of the touch panel are formed, and a display panel which is provided below the touch panel and outputs a video image through the cover glass unit and a manipulation button, wherein the manipulation button is provided in the one or more holes, which are formed in the touch panel and the cover glass unit, to manipulate the game system.

According to embodiments of the present invention, a touch non-sensing area can be eliminated using a conductive member provided at a peripheral part of a hole formed in a touch panel to allow a touch to be normally recognized regardless of whether the hole is formed in the touch panel. Further, when a touch screen panel according to embodiments of the present invention is applied to a game system, a manipulation button of the game system can be installed in the hole area, thereby improving the functionality and securing an aesthetic sense of design.

### BRIEF DESCRIPTION

Some of the embodiments will be described in detail, with reference to the following figures, wherein like designations denote like members, wherein:

FIG. 1 is an exemplary diagram for describing touch non-sensing areas generated by a hole formed in a conventional touch panel;

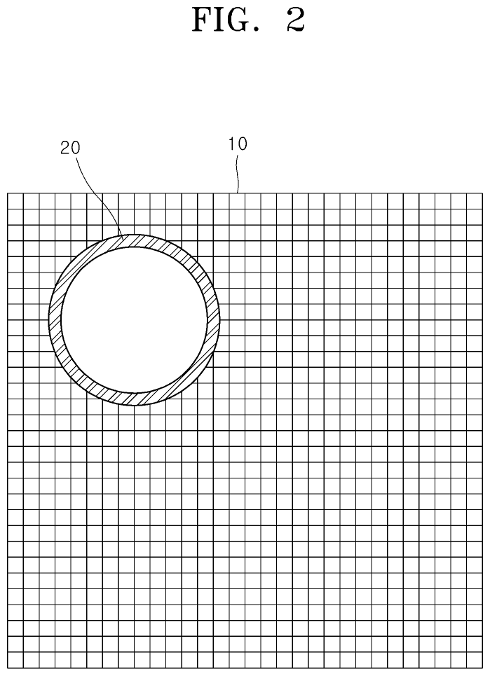

FIG. 2 is an exemplary diagram illustrating a coupling relationship between a touch panel and a conductive member in a touch screen panel according to embodiments of the present invention;

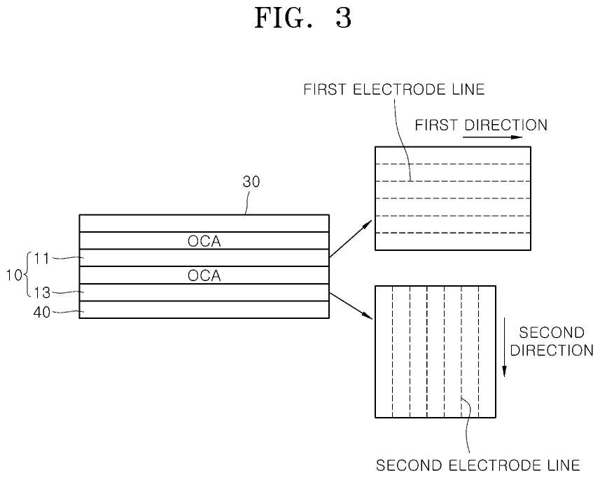

FIG. 3 is an exemplary diagram for describing a stacked structure of a cover glass unit, a touch panel, and a display panel and directions of electrode lines of first and second electrode layers of the touch panel in the touch screen panel according to embodiments of the present invention;

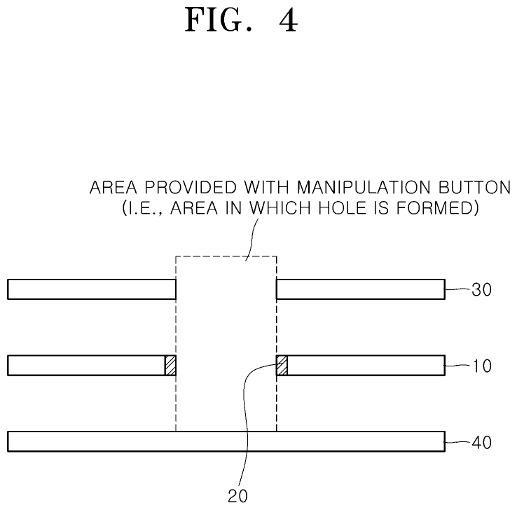

FIG. 4 is an exemplary diagram illustrating a process of electrically connecting first and second electrode lines by a conductive member in the touch screen panel according to embodiments of the present invention; and

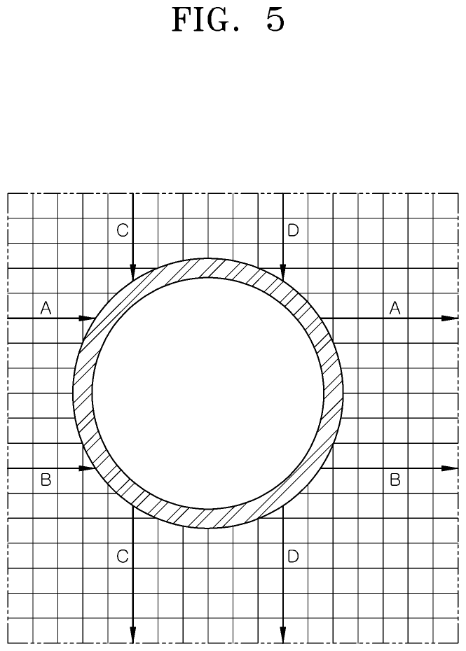

FIG. 5 is an exemplary diagram for describing a stacked structure of the cover glass unit, the touch panel, and the display panel in a state in which a hole is formed in the touch screen panel according to embodiments of the present invention.

### DETAILED DESCRIPTION

Hereinafter, a touch screen panel according to embodiments of the present invention will be described with reference to the accompanying drawings. In this process, thicknesses of lines, sizes of components, and the like illustrated in the drawings may be exaggerated for clarity and convenience of description. In addition, some terms which will be described below are defined in consideration of functions in embodiments of the present invention and meanings may vary depending on, for example, a user or operator's intentions or customs. Therefore, the meanings of these terms should be interpreted based on the scope throughout this specification.

FIG. 2 is an exemplary diagram illustrating a coupling relationship between a touch panel and a conductive member in a touch screen panel according to embodiments of the present invention, FIG. 3 is an exemplary diagram for describing a stacked structure of a cover glass unit, a touch panel, and a display panel and directions of electrode lines of first and second electrode layers of the touch panel in the touch screen panel according to embodiments of the present invention, FIG. 4 is an exemplary diagram illustrating a process of electrically connecting first and second electrode lines by a conductive member in the touch screen panel according to embodiments of the present invention, and FIG. 5 is an exemplary diagram for describing a stacked structure of the cover glass unit, the touch panel, and the display panel in a state in which a hole is formed in the touch screen panel according to embodiments of the present invention.

Referring to FIG. 2, the touch screen panel according to embodiments of the present invention may include a touch panel 10 and a conductive member 20.

The touch panel 10 includes a plurality of transparent electrodes for sensing an electrical signal generated in an area, in which a touch occurs due to a user, that is, a touch area, and has one or more holes. In the present embodiment, the touch panel 10 is implemented using a transparent conductive film to function as a touch sensor that recognizes a user's touch.

The touch panel 10 is formed in a structure in which a first electrode layer 11 and a second electrode layer 13 are vertically stacked. One or more first electrode lines are formed in the first electrode layer 11 to electrically connect the plurality of transparent electrodes in a first direction. The second electrode layer 13 is disposed below the first electrode layer 11, and one or more second electrode lines are formed in the second electrode layer 13 to electrically connect the plurality of transparent electrodes in a second direction orthogonal to the first direction. The first electrode line formed in the first electrode layer 11 functions as a Tx electrode line, that is, a driving line, and the second electrode line formed in the second electrode layer 13 functions as an Rx electrode line, that is, a sensing line.

Meanwhile, the plurality of transparent electrodes of each of the first electrode layer 11 and the second electrode layer 13 may be formed of any one material among indium tin oxide (ITO), indium zinc oxide (IZO), and indium tin zinc oxide (ITZO).

Further, as illustrated in FIG. 3, the first electrode layer 11 and the second electrode layer 13 may be coupled through an optical clear adhesive (OCA), and the touch panel 10 (the first electrode layer 11 thereof) and a cover glass unit 30 to be described below may also be coupled through an OCA.

The touch panel 10 senses an electrical signal generated in the touch area through the transparent electrodes of each of the first electrode layer 11 and the second electrode layer 13, and a control unit (a controller integrated circuit (IC), not illustrated) converts an electrical analog signal transmitted from the touch panel 10 into a digital signal that is generated in the form of coordinates of the touch area in which a touch by a user occurs. A software driver (not illustrated) receives the digital signal, that is, the coordinates of the touch area, from the control unit to control an operation of software.

Meanwhile, when the touch screen panel is applied to the game system as described above, one or more holes may be formed in the touch panel 10 to install a manipulation button in the game system or to secure an aesthetic sense of design. When the hole is formed in the touch panel 10, the first electrode line formed in the first electrode layer 11 and the second electrode line formed in the second electrode layer 13 are disconnected by the formed hole, and thus a touch non-sensing area is generated in which it is impossible to recognize the user's touch. Therefore, in the present embodiment, in order to electrically connect the transparent electrodes that are electrically separated by the one or more holes formed in the touch panel 10, a configuration is adopted in which the conductive member 20 is provided at a peripheral part of the hole. Although an example in which a circular hole is formed is illustrated in FIG. 2, the shape of the hole formed in the touch panel 10 is not limited to a specific shape.

The conductive member 20 may be formed at the peripheral part of the one or more holes formed in the touch panel 10, as illustrated in FIG. 3, so as to connect the first electrode lines disconnected by the hole formed in the first electrode layer 11 and to connect the second electrode lines disconnected by the hole formed in the second electrode layer 13. Here, the peripheral part of the hole may refer to an edge area (e.g., an inner side surface of the hole) of the hole for electrically connecting the first electrode lines disconnected by the hole and electrically connecting the second electrode lines disconnected by the hole.

Specifically, one or more first electrode lines may be formed in the first electrode layer 11. For example, in a case in which a total of N first electrode lines from a 1^{st}-1 electrode line to a 1^{st}-N electrode line are formed in the first electrode layer 11, the conductive member 20 may be formed to electrically connect the first electrode lines each disconnected by the hole. That is, the conductive member 20 may be formed to electrically connect 1^{st}-1 electrode lines disconnected by the hole, electrically connect 1^{st}-2 electrode lines disconnected by the hole, and electrically connect 1^{st}-N electrode lines disconnected by the hole. The same method as the method of electrically connecting the first electrode lines may also be applied to a structure of electrically connecting the second electrode lines disconnected by the hole.

Accordingly, when a hole is formed in the touch panel 10 as illustrated in FIGS. 4 and 5, a first electrode line A (or B) formed at a left side of the hole may be electrically connected to a first electrode line A (or B) formed at a right side of the hole through an electrical bypass path provided by the conductive member 20, and a second electrode line C (or D) formed at an upper side of the hole may be electrically connected to a second electrode line C (or D) formed at a lower side of the hole through an electrical bypass path provided by the conductive member 20.

The conductive member 20 may be formed of silver (Ag) or copper (Cu) at the peripheral part of the hole in order to electrically connect the first and second electrode lines. However, embodiments of the present invention is not limited thereto, and the conductive member 20 may be formed of a conductive metal material capable of electrically connecting the first and second electrode lines.

Meanwhile, the touch screen panel according to the present embodiment may further include the cover glass unit 30 provided in the touch panel 10, which is included in a general touch screen panel, and a display panel 40 provided below the touch panel 10 to output a video image. The display panel 40 may include a liquid-crystal display (LCD), a light-emitting diode (LED), a plasma display panel (PDP), an organic LED (OLED), or the like.

Further, the touch screen panel according to the present embodiment may be mounted on a display device for a game system. In this case, the cover glass unit 30 may have one or more holes formed in an area (i.e., an area of the cover glass unit 30 corresponding to the area in which the hole of the touch panel 10 is formed when the cover glass unit 30 and the touch panel 10 are stacked) corresponding to the area in which the one or more holes of the touch panel 10 are formed.

That is, a manipulation button for manipulating a game system may be provided in a hole which is formed in the touch panel 10 and the cover glass unit 30 as illustrated in FIG. 5. That is, the manipulation button of the game system may be installed in an area of the hole, thereby improving the functionality of the game system and securing an aesthetic sense of design. Further, the display panel 40 may output the video image using not only the cover glass unit 30 but also the manipulation button. (To this end, a structure of a manipulation button for displaying a video image on the manipulation button by the display panel 40 may be designed in advance.) Accordingly, a separate display panel 40 for outputting a separate image to be displayed on the manipulation button is not required, and thus a cost of the game system may be reduced, and the user convenience may be improved by providing a larger display screen to the user.

As described above, in the present embodiment, by eliminating the touch non-sensing area using the conductive member provided at the peripheral part of the hole formed in the touch panel, a touch may be normally recognized regardless of whether the hole is formed in the touch panel. When the touch screen panel according to embodiments of the present invention is applied to the game system, the manipulation button of the game system may be installed in the hole area, thereby improving the functionality of the game system and securing an aesthetic sense of design.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A touch screen panel comprising:
a touch panel including a plurality of transparent electrodes for sensing an electrical signal generated in a touch area and having one or more holes formed therein; and
a conductive member provided at a peripheral part of the one or more holes in order to electrically connect transparent electrodes electrically separated by the one or more holes formed in the touch panel.

2. The touch screen panel of claim 1, wherein the touch panel includes:
a first electrode layer having one or more first electrode lines which electrically connect the plurality of transparent electrodes in a first direction; and
a second electrode layer provided below the first electrode layer and having one or more second electrode lines which electrically connect the plurality of transparent electrodes in a second direction orthogonal to the first direction.

3. The touch screen panel of claim 2, wherein the conductive member is formed to electrically connect the first electrode lines disconnected by the hole formed in the first electrode layer and electrically connect the second electrode lines disconnected by the hole formed in the second electrode layer.

4. The touch screen panel of claim 1, wherein the conductive member is formed of silver (Ag) or copper (Cu) at the peripheral part of each of the one or more holes.

5. The touch screen panel of claim 1, wherein the touch screen panel is mounted on a display device for a game system, and
the touch screen panel further includes:
a cover glass unit provided above the touch panel and having one or more holes formed in an area corresponding to an area in which the one or more holes of the touch panel are formed; and
a display panel which is provided below the touch panel and outputs a video image through the cover glass unit and a manipulation button to manipulate the game system, wherein the manipulation button is provided in the one or more holes formed in the touch panel and the cover glass unit.
